(19) United States
(12) Patent Application Publication
(10) Pub. No.: US 2017/0006379 A1
(43) Pub. Date: Jan. 5, 2017

(54) A Sound Diffusion System for Directional Sound Enhancement

(71) Applicant: ECOLE POLYTECHNIQUE FEDERALE DE LAUSANNE (EPEL), Lausanne (CH)

(72) Inventors: Xavier Falourd, Pully (CH); Patrick Marmaroli, Thonon-les-Bains (FR); Hervé-Jacques Henri Lissek, Renens (CH); Cédric Monchâtre, Neuvecelle (FR); Alexandre Delidais, Saint-Barthélemy (CH); Alain Dufaux, Chambry (CH); Baptiste Crettaz, Sion (CH)

(21) Appl. No.: 15/100,196

(22) PCT Filed: Nov. 18, 2014
(86) PCT No.: PCT/IB2014/066123

§ 371 Date: May 27, 2016

(30) Foreign Application Priority Data
Dec. 3, 2013 (GB) 1321325.1

(51) Int. Cl. H04R 3/04; H04R 1/40

(52) U.S. Cl. CPC H04R 3/04; H04R 1/403; H04R 2203/12; H04R 2201/401

(57) ABSTRACT

A loudspeaker array is described including several circular sound emitters that are bunked. One circular sound emitter can be either a circular array of loudspeakers (kind 1) or a toroidal loudspeaker (kind 2) The loudspeaker array can be composed of circular sound emitters of kind 1, kind 2 or both. A toroidal loudspeaker is a loudspeaker whose membrane is annular and whose enclosure has a central hole. Both toroidal loudspeaker and circular array radiate mainly in their normal axis, i.e., perpendicular to the plane comprising the membrane or the loudspeakers. Circular sound emitters are arranged like an end-fire array so that all the circular sound emitter centers are on the same axis. Each circular sound emitter is driven by its own signal, which results from a filtered version of the input signal, allowing the sound to be focused in the radiation direction.

### FIELD OF THE INVENTION

The present invention relates to the field of sound diffusion systems by means of electroacoustic transducers and more precisely to directional sound diffusion systems. Directional sound diffusion systems aim at creating personalized sound zones by focusing sound in one desired direction

### PRIOR ART

### Directional Sound Diffusion Systems

There are different ways of controlling the directional characteristics of a sound source. Most common techniques are using
line arrays of loudspeakers (planar, curved or linear);
loudspeakers and reflectors (e.g. loudspeaker placed at the focus of a parabolic reflector);
ultrasonic transducer array (heterodyne principle).

The line arrays are constituted of loudspeakers arranged over a straight or curved line. The distance between loudspeakers may be equal (uniform line arrays) or not equal (non-uniform line arrays). Loudspeakers can send signals in phase (broadside line arrays) or delayed signals (oriented line arrays) depending on the direction that one wants the array focus on. An end-fire line array is a particular case of an oriented line array where sound is mainly propagated along the axis of the array (see for example U.S. Pat. No. 4,421,957 and U.S. Pat. No. 5,894,288 A). One typical application of broadside line arrays is a concert where they are positioned vertically for focusing sound mainly at audiences [9].

Another way to focus sound is the use of planar loudspeaker arrays (see for example WO2009/097462). In that case, all arrays are arranged on a plane, and can receive differently delayed signals to achieve a specific directivity. A particular case of the planar loudspeaker arrays is the circular array. It is known that a circular array, whose loudspeakers receive the same signal, has a directivity function equivalent to a zero order Bessel function. This fact makes the circular arrays much more directional than the vibrating plates, the directivity function of which is a first order Bessel function divided by its argument. That kind of structure is used in different sound focusing devices (see for example WO2011/144499 and WO02054379).

The parabolic reflector systems are constituted of one loudspeaker placed in the focus of a parabolic reflector for steering the acoustic rays coming from the loudspeaker towards one single direction (see for example U.S. Pat. No. 5,821,470). Modeling acoustic waves as “rays” does not stay valid anymore when wavelengths are equal or larger than the distance between the loudspeaker and the reflector. That's why for such kind of devices, a tradeoff between the size and the shape of the reflector and the low frequency range must be solved. Because of their small size, commercially available products have limited performances in the low frequencies.

Another technique consists in taking profit of the heterodyne principle, i.e., using the nonlinearities of the medium of propagation to generate audible frequencies with ultrasonic transducers (see for example U.S. Pat. No. 4,823,908, EP1284586 B1, EP1248491 B1, WO2003/019125 A1, EP1175812 B1). When two sounds are propagating through a non-linear medium, two other sounds are created, the frequencies of which are the sum and the difference of the first two frequencies. Those speakers emit two ultrasonic frequencies, whose difference recreates the audible original sound (the signal which is sent to those loudspeakers is a frequency-shifted version of the original audio signal, doubled with a mirror image, both images being scaled down by a factor two (in the frequency domain) so that their range of differences covers the audible spectrum). This technique suffers from different limitations: first of all, the generation of low frequencies supposes to emit high-intensity ultrasounds, which can be harmful for the listeners. Those systems are thus limited in frequencies, having some difficulties to emit in the low frequency range.

### The Case of the Circular Arrays:

Today, circular arrays are mainly used in the fields of medical imaging and underwater acoustics, to achieve a very high directivity factor at one specific frequency in the ultrasonic range. As an example, B-scan is a method for eye and orbit imaging based on a circular shaped-based ultrasonic transducer that focuses a single frequency wave in a highly directional way [2]. The medical ultrasonic emitters use also annular transducers, whose directivity is close to the case of circular arrays [3]. Circular arrays also allow changing the direction of the ultrasonic beam [6].

### Annular Membranes:

Annular (or ring-shaped) membranes have a better directivity factor than plate membranes [5]. This fact is used in the field of ultrasound to achieve highly directional emitters for the needs of the medical imaging (EP1052941). Note that in the medical field, it is common to use piezoelectric arrays of concentric rings, which broadens the frequency bands [3].

The very first studies addressing annular membranes radiation date back to the 1930s [4], [5] page 107 and page 128. In these papers, N. W. Mc Lachlan gave analytical results for directivity and radiated power of vibrating rings. In 1969, A S Merriweather published the analytical acoustic radiation impedance of annular piston, based on Mc Lachlan's works [7]. Acoustic radiation impedance is helpful for determining the ability of a vibrating solid to radiate sound in the surrounding medium (here the air). In 1971, W. Thompson also gives the analytical acoustic radiation impedance of the annular piston by following another method [8].

There are few uses of the annular membranes in the field of audio. Three kinds of devices use such topologies: the first ones are coaxial speakers, popularized from the forties by Altec Lansing [1], which consists in a small high-frequencies loudspeaker that is positioned on the center of a bigger loudspeaker that reproduces the low frequencies. Annular membranes also appear on loudspeakers that use a phase plug, a tapered solid device that is positioned in the center of a membrane and that is used as a waveguide. The third kind of device that uses ring-shaped membranes is the ring resonator, which consists in a ring-shaped passive radiator, which is positioned around the main loudspeaker (see for example GB301437, WO2012/051217). Some other loudspeakers are made with several concentric dome-shaped annular membranes (U.S. Pat. No. 6,320,972, US 2012/0181105), with a phase plug in their center or joining a solid part in the center of the loudspeaker. This technique is used for high-frequencies loudspeakers (“tweeters”), especially in high fidelity systems, since it allows improving the response in the upper part of the spectrum.

Those systems use annular membranes for different practical reasons, but their application is far away from personalized sound zones. Moreover, one can note that the surface of the central tweeter—or phase plug—is usually small compared to the external speaker. The ratio between the inner radius and the outer radius of the greatest speaker is often low (typically less than 0.5) which generally allows considering it as a standard piston.

### BRIEF DESCRIPTION OF THE INVENTION

In a first aspect the invention provides a loudspeaker mounted on a toroidal enclosure, comprising a central hole and a membrane of annular shape.

In a first preferred embodiment of the loudspeaker, an inner radius corresponds to a radius of the central hole and is equal to at least the half of an outer radius of the loudspeaker.

In a second preferred embodiment of the loudspeaker the membrane is substantially shaped according to either one of the following list: flat, dome-shaped or incurved.

In a third preferred embodiment of the loudspeaker the membrane is moved by one or several actuators.

In a fourth preferred embodiment of the loudspeaker the membrane is mounted on a basket or directly on an enclosure with a flexible internal suspension and a flexible external suspension.

In a second aspect the invention provides a sound diffusion system for producing a sound beam comprising:
a three-dimensional loudspeaker array comprising at least two circular sound emitters, each circular sound emitter comprising either a circular array of loudspeakers, or the loudspeaker according to the first aspect or the first to fourth preferred embodiment;
an analog or digital filter unit for each one of the at least two circular sound emitters wherein replica of a primary audio signal are filtered in phase and in amplitude using the respective filter unit for giving at least as many filtered signals as the number of circular sound emitters; and
at least a power amplifier device for each one of the at least two circular sound emitters wherein the filtered signals are amplified resulting in at least as many amplified signals as the number of circular sound emitters and subsequently transmitted to the associated circular sound emitters.

In a fifth preferred embodiment, the sound diffusion system further comprises a further filter, the transfer function amplitude Aᵢ and phase φᵢ of which are given by the following equation at the frequency f (in Hz):

$$\{ \begin{matrix}{A}_{i} = {n}_{i} \times {( - 1 )}^{{a}_{i}} \\ {φ}_{i} = 2 π f ( 1 - {b}_{i} ) \frac{{z}_{i} - {z}_{1}}{c}\end{matrix}$$

whereby acoustical centers of N circular sound emitters belong to the same axis, zᵢ is the position of the i^{th} emitter acoustical center on this axis, the amplitude Aᵢ and phase φᵢ of the transfer function being of the i^{th} filter unit, 1≦i≦N, where c is the sound celerity in air (in m/s), both aᵢ and bᵢ are f-dependent Boolean values (0 or 1), and nᵢ is a positive number.

In a sixth preferred embodiment of the sound diffusion system the circular sound emitters are disposed in parallel.

In a seventh preferred embodiment of the sound diffusion system the circular sound emitters have substantially the same dimensions.

In an eighth preferred embodiment of the sound system the circular sound emitters have their normal axis aligned in a radiation direction.

### BRIEF DESCRIPTION OF THE FIGURES

Examples of the invention will be illustrated by reference to the attached drawings, wherein:

FIG. 1 is a schematic view that illustrates one of the possible uses of the invention, in particular the creation of a personalized sound zone;

FIG. 2 is a block diagram that illustrates the audio signal path inside the system of FIG. 1;

FIG. 3 is an illustration of an example of one circular sound emitter of kind 1 that can be used in the system of FIG. 1;

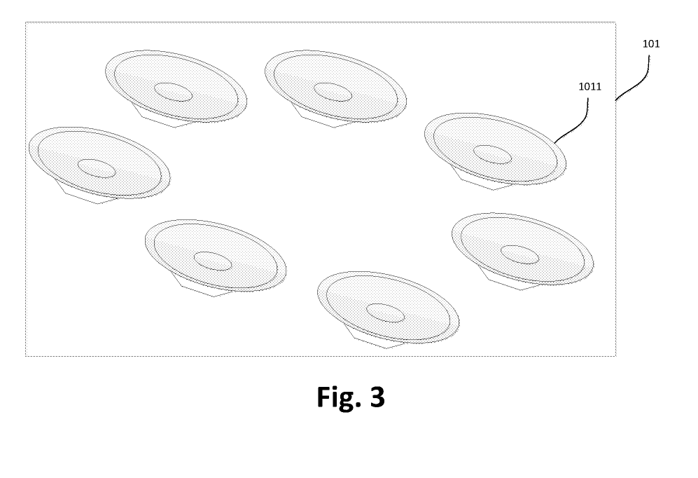

FIG. 4 is an illustration of an example of realization of the circular sound emitter of kind 2 (toroidal loudspeaker) that can be used in the system of FIG. 1;

FIG. 5 is a layout of what can constitute the proposed inventive system;

FIG. 6 is a side view of a system composed of N bunked circular sound emitters.

FIG. 7 is the polar pattern (in dB) resulting from a finite-elements simulation of a circular sound emitter of kind 2 (i.e toroidal loudspeaker), the membrane of which having an inner radius of 15 cm and an outer radius of 19 cm.

FIG. 8 is the polar pattern (in dB) resulting from a finite-elements simulation of a system of three circular sound emitters of kind 1.

### DETAILED DESCRIPTION OF THE PREFERRED EMBODIMENTS

### General Concepts

The present invention merges two concepts: conventional beamformers and circular sound emitters. By circular sound emitter, we mean a sound emitter device the radiation surface of which approximates a circle or a ring (e.g. circular loudspeaker array, annular membrane, horn with annular mouth). Circular sound emitters are known for being more directive than standard loudspeakers of the same overall dimensions. An even higher directivity can be achieved by combining multiple circular sound emitters arranged in the endfire configuration, each radiating a time-delayed version of a primary audio signal (beamforming theory). This document describes how our inventive system takes profit of these two concepts for creating personalized sound zones. The main application of our invention is the creation of personalized sound zones with the underlying idea that the use of multiple systems located next to each other allows the co-existence of distinct and different sound zones in a single venue.

### Inventive System Description

The inventive system comprises a tridimensional array of electroacoustic transducers arranged in several layers of circular sound emitters. A circular sound emitter is either composed of a plurality of loudspeakers arranged in circle (kind 1), or one or several actuators that make an annular membrane vibrate (kind 2). In what follows, circular sound emitter of kind 2 are also called toroidal loudspeaker. Toroidal loudspeaker is an inventive loudspeaker that is described in more detail in the description of the invention. Each circular sound emitter (kind 1 or kind 2) are fed with filtered and amplified audio signals. The characteristics in phase of each filter (angle values of the filter transfer function) depend on the associated circular sound emitter position with respect to the reference circular sound emitter.

The present invention relates to the applications of acoustic beamformers, i.e. sound diffusion systems that enable the sound to be mainly focused in a desired direction. Most of the existing directional sound diffusion systems have showed some limitations for focusing the low frequencies (typically below 300 Hz) with a high directivity factor. The delay-and-sum beamforming is a relevant technique for focusing low frequencies but, when used with traditional loudspeakers, the aperture of the array should be very large (several meters), as well as the number of loudspeakers, to get an high directivity factor. By bunking several circular sound emitters, instead of traditional loudspeakers, our invention provides a solution of smaller aperture than the state of the art for achieving the same directivity factor at low frequencies.

### Modes of Realization

In a first mode of realization, all circular sound emitters constituting the system are circular sound emitters of kind 1. A circular sound emitter of kind 1 is made of a certain number of loudspeakers disposed for approximating a circle with their face oriented so as to radiate in the direction that is perpendicular to the plane of the circle. The loudspeakers can have their own enclosure, or share a tore-shaped enclosure, but the center of the array must remain empty.

In a second mode of realization, all circular sound emitters constituting the system are circular sound emitters of kind 2. A circular sound emitters of kind 2 is made of a certain number of actuators that make an annular membrane vibrate (a flat, dome-shaped or incurved membrane). This annular membrane is mounted on an enclosure that has a center hole. In order to let the sound radiate through the different elements, the inner radius must be at least the half of the outer radius. A circular sound emitter of kind 2 is what toroidal loudspeaker denotes in the following.

In a third mode of realization, both kinds of circular sound emitters are combined for constituting the system.

In all previous modes of realization, the circular sound emitters are aligned in the endfire configuration so that their respective centers belong to the same axis. That permits the sound radiated by one circular sound emitter to pass through the following circular sound emitter(s) in the preferred radiation direction (towards the listener area). This configuration also reduces the diffraction that generally occurs with an endfire array made of loudspeakers with classical enclosures (without hole). The circular sound emitters are all oriented toward the same direction for maximizing the sound pressure on the front side of the system (the side closest to the listener).

### Pros and Cons of the Two Kinds of Circular Sound Emitters

The circular sound emitter of kind 1 is easily realizable with existing loudspeakers, and leaves to the manufacturer some freedom of design. The circular sound emitter of kind 2 imposes the design of the annular membrane. However, the annular membrane brings several improvements in comparison with a circular loudspeaker array: firstly, the annular membrane is symmetrical around its normal axis making the directivity smoother than those obtained with a finite number of loudspeakers arranged in a circular array. Secondly, the radiation area of an annular membrane is larger than the summation of all the loudspeaker radiation areas. That improves the restitution of low frequencies.

Possible Applications of Circular Sound Emitter when Used Alone

The use of a single toroidal loudspeaker or a single circular loudspeaker array may have some interests because:
1) A circular sound emitter has a higher directivity factor than a traditional loudspeaker. It can be of interest for focusing sound over an audience while avoiding walls and ceil and so limit reflections and power lose.
2) The high directivity factor of the toroidal loudspeaker is also interesting for its extended frequency range in the focusing direction. Since the directivity factor increases with the frequency, the higher the frequency, the more the energy in the preferred radiation direction.
3) The center of a circular sound emitter is empty. That can be useful for achieving active noise control on the mouthpiece of an air duct. Moreover, some active or passive materials (lights, camera, smartphone, . . . ) can be inserted in the hole of the device.

### Possibility of Improvement

With all modes of realization, a parabolic or hemispheric reflector can be used to reflect the sound toward the preferred radiation direction (it must then be placed on the rear side of the system, and oriented toward the front side).

Some absorbers (porous, resonant or electroacoustic) can also be disposed on the sides of the system to improve its directivity. Those solutions can be useful for devices in a reverberant environment.

### Preferred Example Embodiments

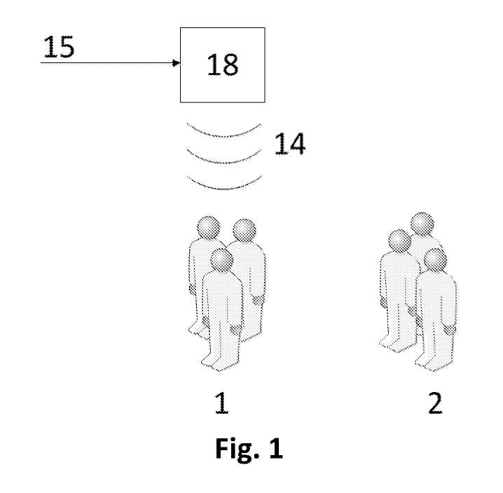

An example of environment in which the method and device can be used is illustrated in FIG. 1. In this setting, a group of people 1 in a museum, a restaurant or a waiting room would like to listen to the sound 14 diffused by the sound diffusion system 18 whereas another group 2, close to the first one, does not want to be disturbed by the sound 14, or would like to be immerged in another sound atmosphere.

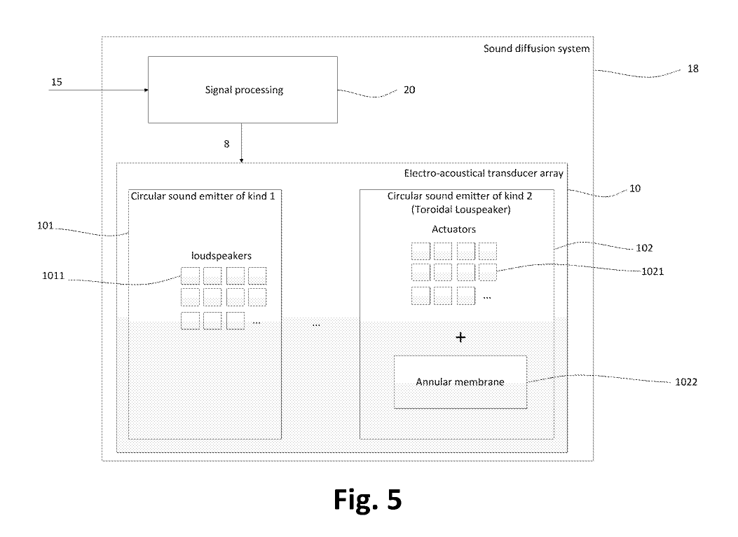

A global layout of the sound diffusion system 18 is depicted in FIG. 5. It is composed of a signal-processing block 20 the input of which is the user audio signal 15 and the output is the filtered signals delivered to all the circular sound emitters.

In the first example mode of realization, the sound diffusion system 18 comprises N circular sound emitters of kind 1 (101), i.e., made of M electrodynamic loudspeakers 1011 arranged in circle. In a preferred embodiment, N and M are both integer values with N superior or equal to 2 and M superior or equal to 3.

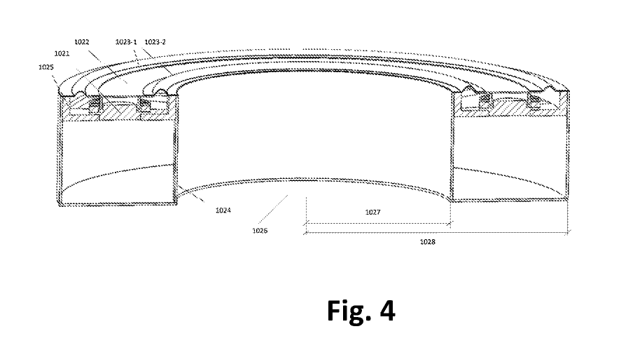

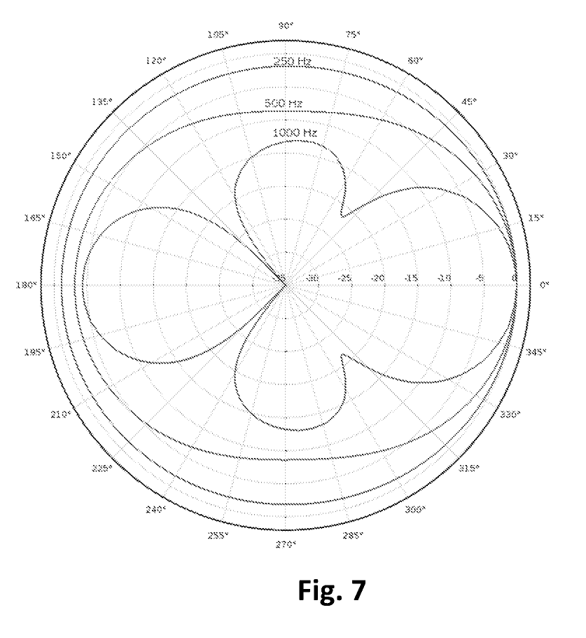

In the second example mode of realization, the sound diffusion system 18 comprises N toroidal loudspeakers as 102 in FIG. 4. The membrane 1022 is mounted on a basket 1025, with flexible internal and external suspensions 1023-1 1023-2, and moved with actuators 1021 that are clamped on the basket, which is mounted itself on an enclosure 1024 that has a central hole 1026. The membrane can also be mounted directly on the enclosure if the actuators are fixed in the enclosure. The membrane can be moved either by one single actuator that transmits the force on the whole membrane circumference, or by several actuators distributed on the membrane. In this mode of realization, electrodynamic actuators are used, but they can also be electrostatic or piezoelectric. The inner radius 1027 of the toroidal loudspeaker must be at least equal to the half of its outer radius 1028, so that the sound can radiate through the different elements of the endfire. As an example, FIG. 7 depicts a polar pattern (in relative dB) of a toroidal loudspeaker the membrane of which having an inner radius of 15 cm and an outer radius of 19 cm. This picture results from a finite-elements simulation.

The N circular sound emitters 101 or 102 are located on parallel plans so that their respective centers belong to the same axis, and oriented toward the listener area (preferred radiation direction).

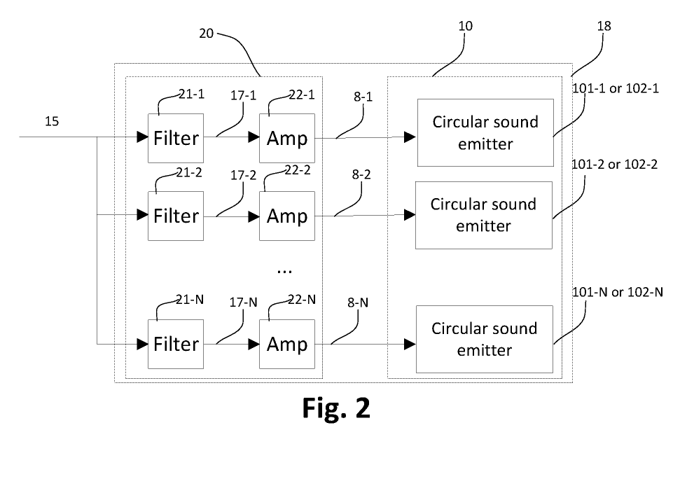

As illustrated in FIG. 2, the audio signal feeding each circular sound emitter is independent. The typical audio path is the following: a primary audio signal 15 coming from any cabled or wireless audio device, e.g., a smartphone, is processed by N digital or analog filters 21-1, 21-2, . . . , 21-N. It is here assumed that digital filters are composed of an analog to digital converter, a digital filter device and a digital to analog converter. One filter unit 21 modifies the amplitude spectrum and the phase spectrum of the primary signal 15. This procedure gives N filtered signals 17-1, 17-2, . . . , 17-N. Each filtered signal 17 is amplified by a power amplifier device 22-1, 22-2, . . . , 22-N. The resulting amplified signals 8-1, 8-2, . . . , 8-N are finally those that feed each circular sound emitter of kind 1 or of kind 2 101-1 or 102-1, 101-2; 102-2, . . . , 101-N or 102-N. Several power amplifier devices per circular sound emitter can be used if more power is needed to drive all the loudspeakers or actuators of the circular sound emitters.

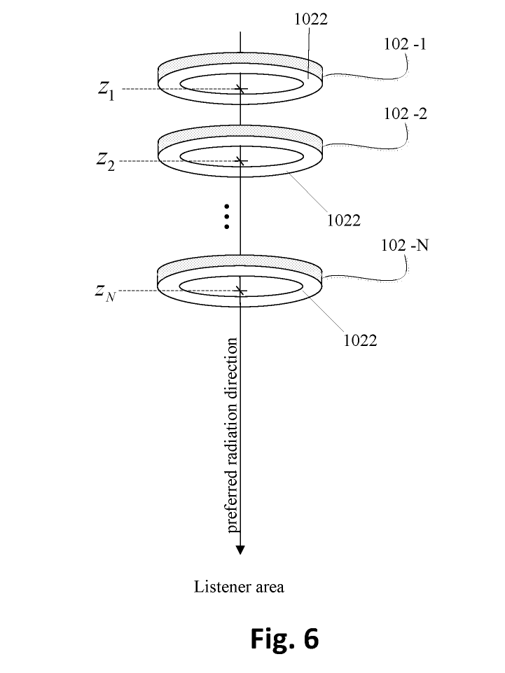

In a preferred embodiment, the acoustical centers of the N circular sound emitters belong to the same axis which points towards the listener area (see FIG. 6). Let call zᵢ the position of the i^{th} emitter acoustical center on this axis. It is considered in what follows that the N^{th} circular sound emitter is the nearest one to the listener. The amplitude Aᵢ and phase φᵢ of the transfer function of the i^{th} filter unit, 1≦i≦N, are given at the frequency f (in Hz) by:

$$\{ \begin{matrix}{A}_{i} = {n}_{i} \times {( - 1 )}^{{a}_{i}} \\ {φ}_{i} = 2 π f ( 1 - {b}_{i} ) \frac{{z}_{i} - {z}_{1}}{c}\end{matrix} \qquad ( 1 )$$

where cis the sound celerity in air (in m/s), both aᵢ and bᵢ are f-dependent Boolean values (0 or 1), and nᵢ is a positive number. The role of aᵢ is to reinforce, when equals 0, or to attenuate, when equals 1, the sound pressure inherent to the frequency f in the preferred radiation direction, when bᵢ=0, or in the plane perpendicular to the preferred radiation direction, when bᵢ=1. The factor nᵢ permits to adjust the amplitude of the signal delivered by the i^{th} circular sound emitter according to the amount of acoustic energy to reinforce or to attenuate.

As an example, in case of N=2, a strategy could be to reinforce sound in the preferred radiation direction over a certain range of frequencies (typically high frequencies) while, at the same time, to attenuate sound in the plane perpendicular to the preferred radiation direction over another range of frequencies (typically low frequencies). This can be achieved by setting:

$${n}_{1} = {n}_{2} = 1 , \\ {a}_{1} = 0 ∀ f , \\ {a}_{2} = \{ \begin{matrix}1 & if f \leq {f}_{c} \\ 0 & otherwise\end{matrix} , \\ {b}_{1} = 0 ∀ f , \\ {b}_{2} = \{ \begin{matrix}1 & if f \leq {f}_{c} \\ 0 & otherwise\end{matrix} . \qquad ( 2 )$$

where f_{c} is the cut-frequency (in Hz) below which the sound energy should be attenuated in the plane perpendicular to the preferred radiation direction and above which the sound energy is reinforced in the listener area.

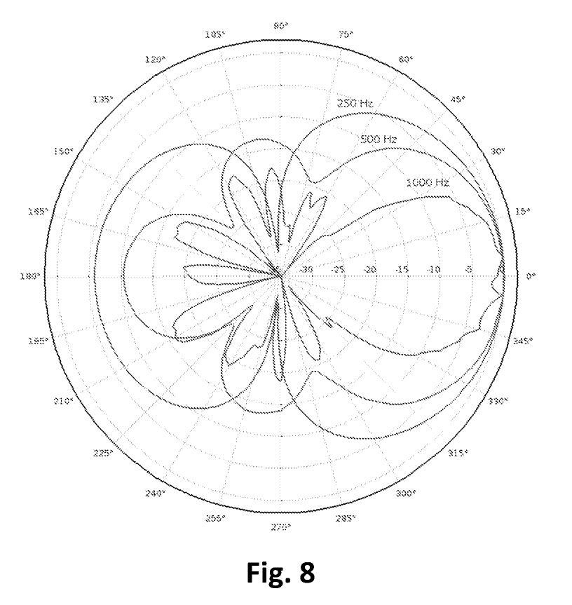

As an example, the FIG. 8 depicts the simulated polar pattern (in dB) of a sound diffusion system composed of N=3 circular sound emitters of kind 1 with following parameters:

$${z}_{1} = 0 cm , \\ {z}_{2} = 20 cm , \\ {z}_{3} = 60 cm , \\ {n}_{1} = {n}_{2} = 1 , \\ {n}_{3} = 2 , \\ {a}_{1} = {a}_{2} = 0 ∀ f , \\ {a}_{3} = \{ \begin{matrix}1 & if f \leq {f}_{c} \\ 0 & otherwise\end{matrix} , \\ {b}_{1} = {b}_{2} = 0 ∀ f , \\ {b}_{3} = \{ \begin{matrix}1 & if f \leq {f}_{c} \\ 0 & otherwise\end{matrix} , \\ {f}_{c} = 400 Hz .$$

### REFERENCES

[1] George L. Augspurger. Theory, ingenuity, and wishful wizardry in loudspeaker design—a half-century of progress? Journal of the Acoustical Society of America, 77(4):1303-1308, 1985.
[2] Christoph B. Burkhardt, Pierre-Andr-Grandchamp, and Heinz Hoffmann. Focusing ultrasound over a large depth with an annular transducer. IEEE transactions on Sonics and Ultrasonics, 22(1):11-15, 1975.
[3] B. W. Drinkwater and Paul D. Wilcox. Ultrasonic arrays for non-destructive evaluation: A review. NDT&E International, 39:525-541, 2006.
[4] N. W. Mc Lachlan. Verteilung der schallstrahlung von kreisscheiben mit knotenlinien. Annalen der Physik, cycle 5, 15:422-439, 1932.
[5] N. W. Mc Lachlan. Loud Speakers. Clarendon Press, 1934.
[6] H. Masuyama, K. Mizutani, and K. Nagai. Sound source with direction-variable beam using annular transducer array. In Proceedings of the IEEE Ultrasonics Symposium., volume 2, pages 1097-1100 vol. 2, 2002.
[7] A. S. Merriweather. Acoustic radiation impedance of a rigid annular ring vibrating in an infinite rigid baffle. Journal of Sound and Vibration, 10(3):369-379, 1969.
[8] W. Thompson. The computation of self- and mutual-radiation impedances for annular and elliptical pistons using bouwkamps integral. Journal of Sound and Vibration, 17(2):221-233, 1971.

1-10. (canceled)

11. A loudspeaker mounted on a toroidal enclosure, comprising:
a central hole; and
a membrane of annular shape.

12. The loudspeaker of claim 11, wherein an inner radius of the central hole is equal to at least the half of an outer radius of the loudspeaker.

13. The loudspeaker of claim 11, wherein the membrane is at least one of substantially flat shaped, dome-shaped, and incurved.

14. The loudspeaker of claim 11, further comprising:
an actuator,
wherein the membrane is movable by the actuator.

15. The loudspeaker of claim 11, wherein the membrane is mounted on a basket or directly on an enclosure with a flexible internal suspension and a flexible external suspension.

16. A sound diffusion system for producing a sound beam comprising:
a three-dimensional loudspeaker array comprising at least two circular sound emitters, each circular sound emitter including a circular array of loudspeakers;
an analog or digital filter unit for each one of the at least two circular sound emitters, replica of a primary audio signal are filtered in phase and in amplitude using the respective filter unit for giving at least as many filtered signals as the number of circular sound emitters; and
at least a power amplifier device for each one of the at least two circular sound emitters, the filtered signals are amplified resulting in at least as many amplified signals as the number of circular sound emitters and subsequently transmitted to the associated circular sound emitters.

17. The system of claim 16, further comprising:
an additional filter, a transfer function amplitude Aᵢ and phase φᵢ of which are given by the following equation:
$$\{ \begin{matrix}{A}_{i} = {n}_{i} * {( - 1 )}^{{a}_{i}} \\ {φ}_{i} = 2 π f ( 1 - {b}_{i} ) \frac{{z}_{i} - {z}_{1}}{c}\end{matrix}$$
wherein acoustical centers of N circular sound emitters belong to a same axis, zᵢ is a position of the i^{th} emitter acoustical center on the same axis, the amplitude Aᵢ and phase φᵢ of the transfer function being of the i^{th} filter unit, 1≦i≦N, wherein c is the sound celerity in air expressed in m/s, both aᵢ and bᵢ are f-dependent Boolean values (0 or 1), and nᵢ is a non-zero positive real number.

18. The system of claim 16, wherein the circular sound emitters are disposed in parallel.

19. The system of claim 16, wherein the circular sound emitters have substantially a same dimension.

20. The system of claim 16, wherein the circular sound emitters have their normal axis aligned in a radiation direction.
